(19) United States
(12) Patent Application Publication
(10) Pub. No.: US 2019/0164450 A1
(43) Pub. Date: May 30, 2019

(54) MATH WORKSHEET

(71) Applicant: Chan Wang BOHACHEFF, Charlotte,, NC (US)

(72) Inventor: Chan Wang BOHACHEFF, Charlotte, NC (US)

(21) Appl. No.: 16/091,759

(22) PCT Filed: Apr. 7, 2017
(86) PCT No.: PCT/US17/26559

§ 371 Date: Oct. 5, 2018

Related U.S. Application Data
(60) Provisional application No. 62/319,658, filed on Apr. 7, 2016.

(51) Int. Cl. G09B 19/02

(52) U.S. Cl. CPC G09B 19/02

(57) ABSTRACT

Math worksheets are described herein having design and technical features for teaching accurate number positioning for various mathematical operations. For example, a math worksheet comprises a medium having one or more equation modules marked thereon, an equation module comprising horizontal lines defining adjacent rows. Columns divide the adjacent rows into blocks in which numbers or portions thereof are to be written, wherein the columns have width less than width of the blocks and provide spacing between individual numbers and mathematical operators.

### RELATED APPLICATION DATA

The present application claims priority pursuant to 35 U.S.C. § 119(e) to U.S. Provisional Patent Application Ser. No. 62/319,658 filed Apr. 7, 2016 which is incorporated herein by reference in its entirety.

### FIELD

The present invention relates to learning aids and, in particular, to worksheets for practicing and improving math skills.

### BACKGROUND

When teaching math to grade school students, teachers and parents often use traditional notebook paper. In some cases, graph paper is employed if students are required to chart or illustrate results of mathematical operations. Notebook paper and graph paper are less than ideal media for mathematical instruction. Notebook paper fails to provide any spatial guidance for aligning numbers in various mathematical operations including addition, subtraction, multiplication and division. Therefore, students can find it difficult properly align numbers, which can lead incorrect answers to math problems. Moreover, individual cells of graph paper are prohibitively small for receiving handwritten numbers.

### SUMMARY

In view of these problems, math worksheets are described herein having design and technical features for teaching accurate number positioning for various mathematical operations. For example, a math worksheet comprises a medium having one or more equation modules marked thereon, an equation module comprising horizontal lines defining adjacent rows. Columns divide the adjacent rows into blocks in which numbers or portions thereof are to be written, wherein the columns have width less than width of the blocks and provide spacing between individual numbers and/or mathematical operators. In some embodiments, at least one row comprises fewer blocks than an adjacent row. Moreover, one or more rows or blocks can have shading or texture differentiating the row or block from the remainder of the equation module. Math worksheets described herein are not limited to any particular medium. In some embodiments, the medium of the math worksheet comprises paper, plastic, glass or an electronic medium or various combinations thereof.

These and other embodiments are described in greater detail in the following detailed description.

### BRIEF DESCRIPTION OF THE DRAWINGS

FIG. 1 illustrates a math worksheet according to some embodiments.

FIG. 2 illustrates equation modules of FIG. 1 wherein blocks have been filled with numbers on which a student will perform a mathematical operation according to some embodiments.

FIG. 3 illustrates a math worksheet wherein the equation modules are limited to the ones place value according to some embodiments.

FIG. 4 illustrates equation modules of FIG. 3 wherein blocks have been filled with numbers on which a student will perform a mathematical operation according to some embodiments.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

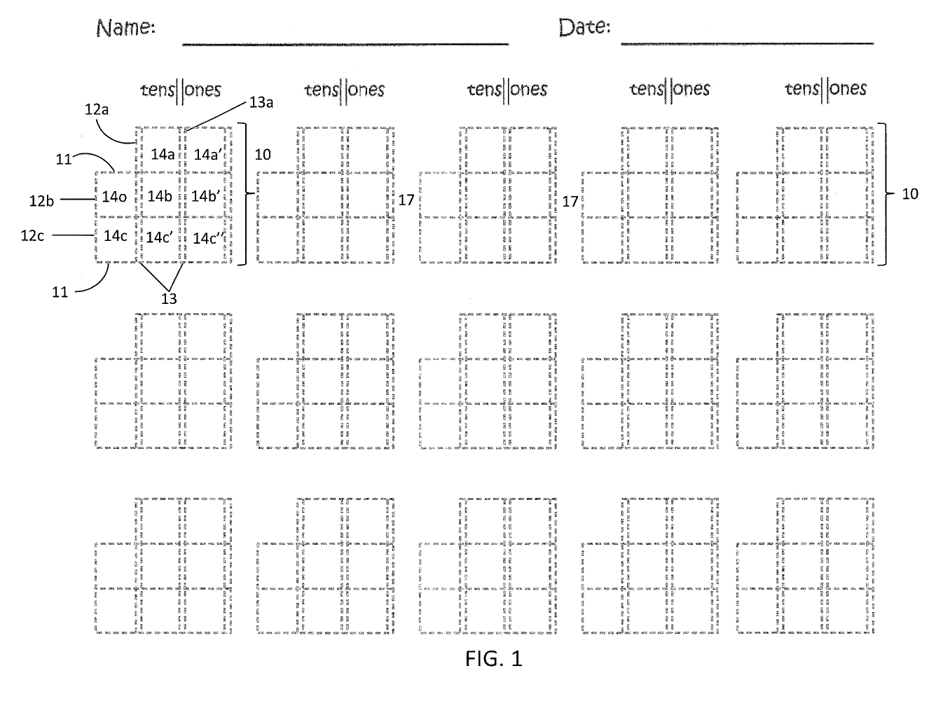

Referring to the embodiment of FIG. 1, a math worksheet comprises a medium having one or more equation modules 10 marked thereon. Any medium not inconsistent with the objectives of the present invention can be employed. For example, the equation modules can be marked on paper, plastic, glass, metal or various combinations thereof. Moreover, the medium can be an electronic medium such as that associated with a computer, tablet or smartphone. Suitable stylus apparatus can be used for handwriting when the aid is in electronic format. Non-writing space 17 is positioned between the equation modules 10. An equation module 10 comprises horizontal lines 11 defining adjacent rows 12 including a top row 12a, a center row 12b and a bottom row 12c. Columns 13 divide the adjacent rows 12 into blocks 14 in which numbers or portions thereof are to be written. As illustrated in FIG. 1, the columns 13 have width less than width of the blocks 14. Importantly, width of the columns 13 is sufficient to provide spacing between individual numbers. For example, column width can generally be 10 percent to 70 percent of block width. In some embodiments, column width is has a value selected from Table I.

TABLE I
Column Width
Percent of Block Width
15-60
20-50
25-50
30-40
15-35
20-40

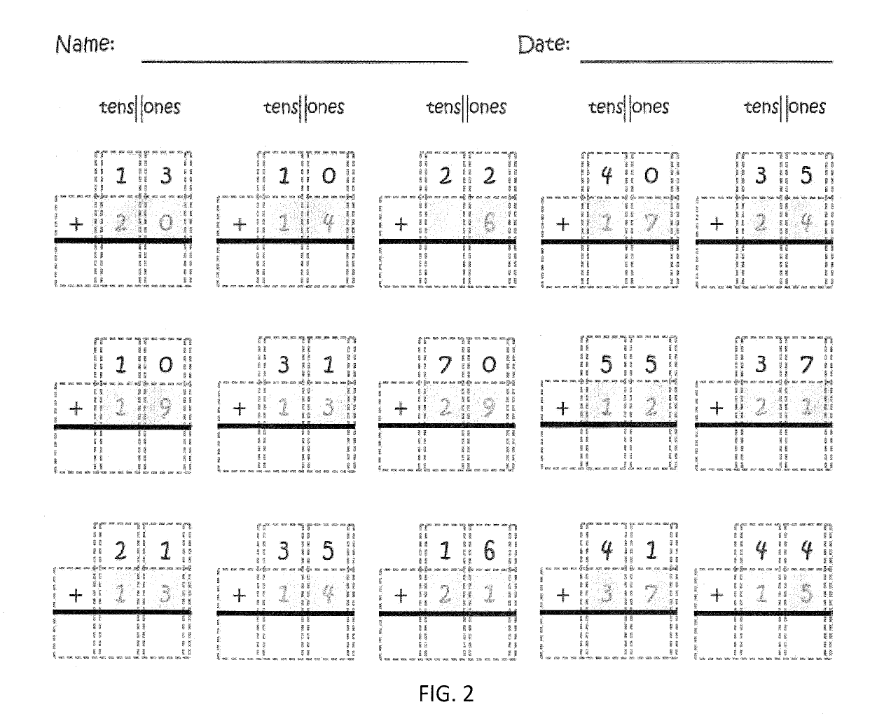

Column width also provides users of the math worksheet a substantial visual cue that is easily contrasted with the number blocks 14. In some embodiments, a column is defined by at least two vertical lines. Spacing of the vertical lines sets the column width. One or more columns 13 also assign place values for the blocks 14. In the embodiment of FIG. 1, column 13a divides or arranges the blocks 14 into “ones” and “tens” columns. As described further herein, this can assist the student in learning and recognizing number place values resulting in proper placement and alignment of numbers for mathematical operations including addition, subtraction, division and multiplication. As the equation module 10 of FIG. 1 addresses double digit math operations, such as double digit addition or subtraction, the top row 12a is limited to a tens block 14a and a ones block 14a′. The center row 12b also comprises tens block 14b and ones block 14b′. However, the center row also comprises a mathematical operator block 14o. For example, the mathematical operator block 14o can contain a plus sign (+), minus sign (−), multiplication sign (x) or division sign. Accordingly, the operator block 14o informs the student of the mathematical operation of the equation module. The bottom row 12c serves as the row in which the answer of the mathematical operation is placed. Depending on the specific mathematical operation, the answer may exceed two digits. Therefore, the answer row 12c comprises three blocks 14c, 14c′ and 14c″. Alternatively, the answer may be a single digit, and the answer row is limited to a single block. In some embodiments, block number of the answer row equals digit number of the answer. This can provide students clues as to whether regrouping will be required for the answer. In some embodiments, the horizontal line separating the answer row 12c from the center row 12b can be highlighted, bolded or otherwise differentiated from the remaining horizontal lines of the equation module. FIG. 2 illustrates equation modules of FIG. 1 wherein blocks have been filled with numbers on which a student will perform a mathematical operation according to some embodiments.

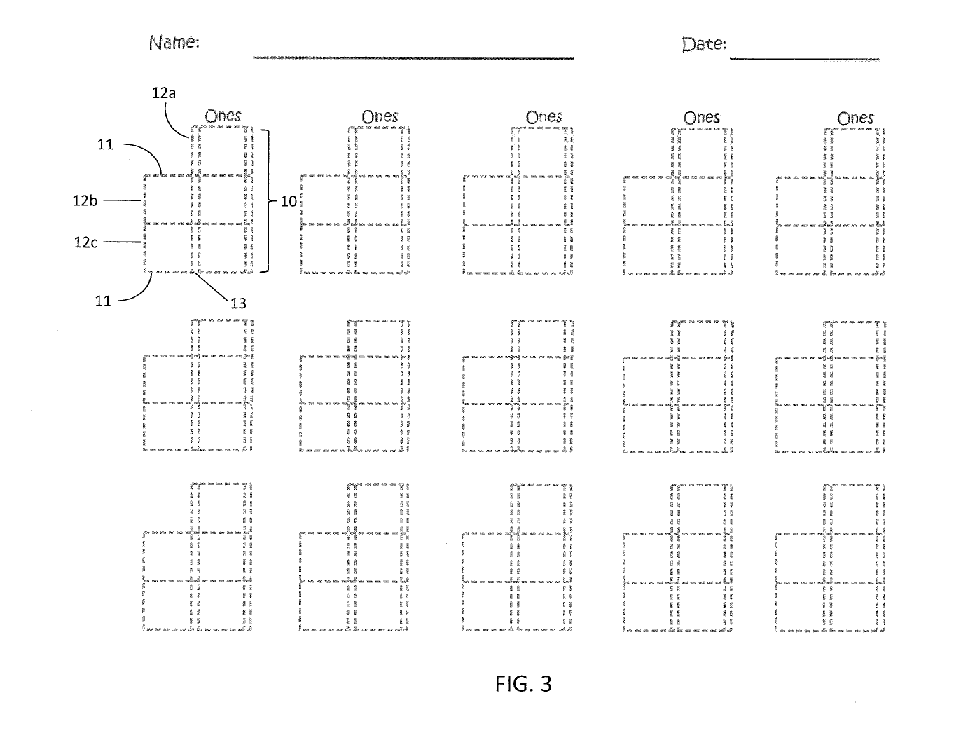

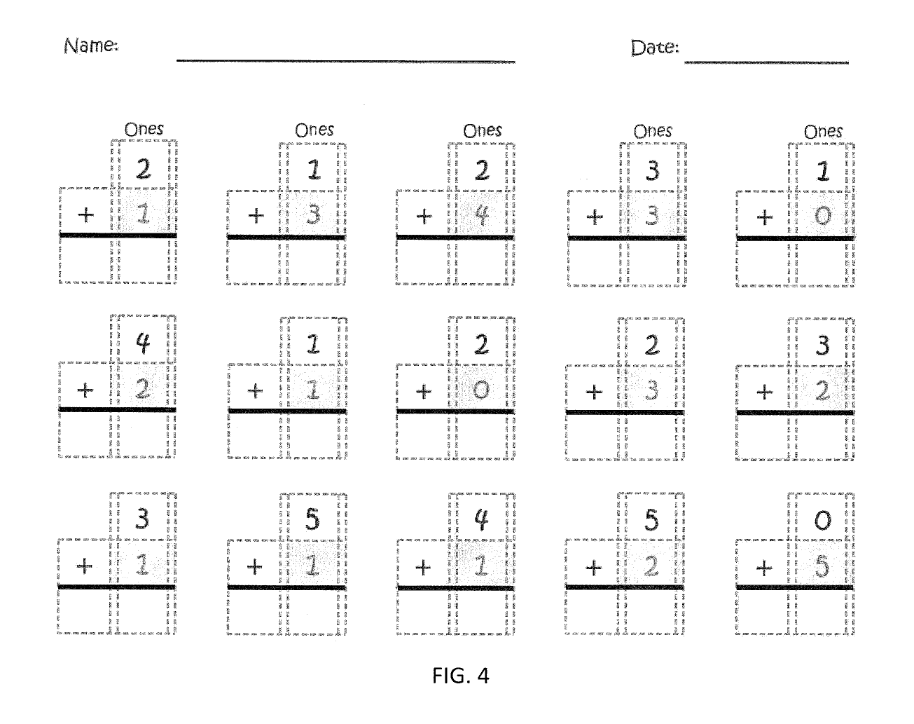

An equation module can have any desired number of place value blocks for a row. In some embodiments, a row of an equation module can be limited to the ones place value. FIG. 3 illustrates a math worksheet wherein the equation modules are limited to the ones place value according to some embodiments. The equation modules of FIG. 3 contain the same general components as the modules of FIG. 1. FIG. 4 illustrates equation modules of FIG. 4 wherein blocks have been filled with numbers on which a student will perform a mathematical operation according to some embodiments. In other embodiments, a row of an equation module can extend to the tens, hundreds, thousands, ten thousands, hundred thousands, millions place values or greater. In further embodiments, a column running between adjacent blocks can serve as a decimal place. In this way, math worksheets can serve to teach mathematical operations involving decimals. One or more columns running between adjacent blocks can also serve as spaces for commas, thereby teaching students about proper comma placement for large numbers and orders of magnitude.

In some embodiments, an equation module comprises regrouping boxes or spaces. Regrouping boxes or spaces can be positioned above boxes of the top row, in some embodiments. Regrouping boxes can be visually differentiated from boxes of the rows. In some embodiments, for example, regrouping boxes are smaller than boxes of the equation module rows.

In some embodiments, one or more blocks can exhibit shading, bolding and/or other features differentiating the block(s) from other blocks of the equation module. As discussed above, the operator block 14o can have one or more differentiating features. Moreover, regrouping boxes can be shaded, bolded, highlighted or otherwise visually differentiated in the equation module. As illustrated in FIGS. 2 and 4, an entire row of boxes can be highlighted. Equation modules of math worksheets can be provided in fillable format wherein the teacher or student enters numbers of the equation. In some embodiments, the operator box is also blank and can be filled in by the teacher or student. In other embodiments, equation modules are prefilled with numbers on which the student will perform the intended mathematical operation. FIGS. 2 and 4 illustrate prefilled math worksheets according to some embodiments.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A math worksheet comprising:
a medium having one or more equation modules marked thereon, an equation module comprising horizontal lines defining adjacent rows and columns dividing the adjacent rows into blocks in which numbers or portions thereof are to be written, wherein the columns have width less than width of the blocks and provide spacing between individual numbers, mathematical operators or combinations thereof.

2. The math worksheet of claim 1, wherein at least one row comprises fewer blocks than an adjacent row.

3. The math worksheet of claim 2, wherein the equation module comprises a mathematical operator block.

4. The math worksheet of claim 1, wherein one of the horizontal lines is visually differentiated to define an answer row of blocks.

5. The math worksheet of claim 1, wherein one or more rows of the equation module are limited to ones place value.

6. The math worksheet of claim 1, wherein one or more rows of the equation module extend to tens place value.

7. The math worksheet of claim 1, wherein the equation module further comprises one or more regrouping spaces.

8. The math worksheet of claim 7, wherein the regrouping spaces comprise blocks arranged over a top row of the equation module.

9. The math worksheet of claim 8, wherein the regrouping blocks are visually differentiated from blocks of the rows.

10. The math worksheet of claim 9, wherein the regrouping blocks are smaller than the blocks of the rows.

11. The math worksheet of claim 9, wherein the regrouping blocks have a dashed border.

12. The math worksheet of claim 1, wherein blocks of at least one row are shaded.

13. The math worksheet of claim 1, wherein blocks of the equation module are prefilled with numbers.

14. The math worksheet of claim 1, wherein a block of the equation module is prefilled with a mathematical operator.

15. The math worksheet of claim 1, wherein a column between adjacent blocks contains a decimal point.

16. The math worksheet of claim 1, wherein a column between adjacent blocks contains a comma.
